(19) United States
(12) Patent Application Publication
(10) Pub. No.: US 2008/0266654 A1
(43) Pub. Date: Oct. 30, 2008

(54) Extreme ultraviolet microscope

(75) Inventors: Vadim Yevgenyevich Banine, Helmond (NL); Arno Jan Bleeker, Westerhoven (NL); Vladimir Vitalevich Ivanov, Moscow (RU); Konstantin Nikolaevich Koshelev, Troitsk (RU); Frank Jeroen Pieter Schuurmans, Valkenswaard (NL); Vladimir Mihailovitch Krivtsun, Troitsk (RU); Maarten Marinus Johannes Wilhelmus Van Herpen, Heesch (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/790,681

(22) Filed: Apr. 26, 2007

(51) Int. Cl. G02B 21/00

(52) U.S. Cl. 359/368; 359/359

(57) ABSTRACT

An extreme ultraviolet (EUV) microscope configured to analyze a sample. The microscope includes a source of EUV radiation constructed and arranged to generate the EUV radiation with a wavelength at least in a range of about 2-6 nm, and an optical system constructed and arranged to illuminate the sample with the EUV radiation and to collect a radiation emanating from the sample. The optical system is arranged with at least one mirror that includes a multilayer structure for in-phase reflection of at least a portion of the radiation in the range of about 2-6 nm.

### FIELD

The invention relates to an extreme ultraviolet (EUV) microscope for analysing a sample.

### BACKGROUND

An embodiment of an ultraviolet microscope is known from U.S. Pat. No. 5,450,463, hereby incorporated by reference in its entirety. The microscope is arranged with a source emitting ultraviolet radiation in a range of 43.7 to 65 angstroms. The X-ray microscope is arranged for providing an X-ray transmission image, whereby in order to enable a suitable image contrast a non-linear optical medium is provided in a vacuum chamber in which an X-ray optical system of the X-ray microscope is installed. In this embodiment, X-ray radiation rays having a wavelength longer than that of the ultraviolet rays are made incident upon the non-linear optical medium to convert said radiation rays into ultraviolet rays, and the converted ultraviolet rays are made incident upon a sample to be examined.

Another embodiment of an X-ray microscope is known from U.S. Pat. No. 5,107,526, hereby incorporated by reference in its entirety. The microscope is arranged to generate X-rays in a wide spectrum. The illuminating system of the microscope comprises a highly polished primary mirror and a highly polished secondary mirror, both mirrors being coated with a specific multilayer structure. For the multilayer structure, a Tungsten/Silicon multilayer having pre-selected K- and L-absorption edges is used. This has an effect of a substantial transmission of X-rays through the bandpass of the water window (2-6 nm) and of a substantial rejection of ultraviolet and visible radiation wavelengths outside the bandpass of the water window.

The present invention relates to an EUV microscope that provides various advantages over prior art microscopes, such as X-ray microscopes.

### SUMMARY

It is an aspect of the present invention to provide an EUV microscope with a simple architecture, yet enable high quality images of the sample.

In an embodiment, an EUV microscope is provided. The EUV microscope includes an optical system constructed and arranged with at least one mirror comprising a multilayer structure for in-phase reflection of at least a portion of the radiation in the range of about 2-6 nm.

In an embodiment, an EUV microscope configured to analyze a sample is provided. The EUV microscope includes a source of EUV radiation constructed and arranged to generate the EUV radiation with a wavelength in a range of about 2-6 nm, and an optical system constructed and arranged to illuminate the sample with the EUV radiation and to collect a radiation emanating from the sample. The optical system is arranged with at least one mirror comprising a multilayer structure for in-phase reflection of at least a portion of the radiation in the range of about 2-6 nm.

By providing a suitably formed multilayer structure arranged for in-phase reflection of the portion of the EUV radiation, the typically rigidly formulated specifications for a suitable source of extreme ultra-violet radiation may be relaxed, thereby substantially simplifying the architecture of the microscope and substantially reducing its production costs.

The source specifications for the EUV microscope may be relaxed with respect to bandwidth, because the optics arranged for the EUV microscopy may accept a much larger bandwidth then the commonly used zone plate. This may allow the effective (used) output of the source to be larger. Furthermore, the output of the new sources is 100 times larger then the sources used so-far. Moreover, the transmission of an optical system based on multilayer coated mirrors is much larger then one based on a zone plate due to the higher reflectivity of the mirrors and the larger accepted bandwidth.

Suitable materials for production of the multilayer structure for in-phase reflection of the EUV radiation may include any one of the following combinations of materials: Mo/B; La/B₄C; Mo/B₄C; Ru/B₄C; FeCrNi/B₄C; W/B₄C; Al₂O₃/C; Co/C; Ni/C; CrB₂/C; RhRu/C; Ru/C; W/C; V/C; NiCr/C; Fe/C; Ru/C; CO₂C₃/C; Ge/C; FeCrNi/C; W/Sc; Cr/Sc; Al₂O₃/V; Cr/V; Ni/V; Cr/Ti; C/Ti; W/Ti; and Ni/Ti. These multilayers may be relatively easily obtained, and may provide a superior multilayer mirror for EUV microscopy. A suitable EUV source for the EUV microscope according an embodiment may comprise either a discharge plasma source or a laser induced plasma source. The multilayer structure may be arranged with a plurality of alternating first layers and second layers, whereby the first layer comprises a first material and a second layer comprises a second material. The plurality may be chosen in a range of about 200-500 alternating layers. The multilayer structure may be formed by a repetition of a unit structure having the first layer and the second layer. The unit structure may have a thickness in a range of about 1-2 nm. The unit structure may have a thickness of about 1.5 nm. This may enable in-phase reflection of the EUV radiation having a wavelength in the range of about 3.10-3.13 nm. A thickness of the first layer may be in a range of about 40%-60% of the thickness of the unit structure. The thickness of the first layer may be about 0.6-1.5 times the thickness of the second layer.

### BRIEF DESCRIPTION OF THE DRAWINGS

These and other aspects of the invention will be discussed in more detail with reference to drawings.

FIG. 1 presents a schematic view of an embodiment of an EUV microscope according to the present invention; and

FIG. 2 presents a schematic view of an embodiment of the EUV microscope according to the present invention.

### DETAILED DESCRIPTION

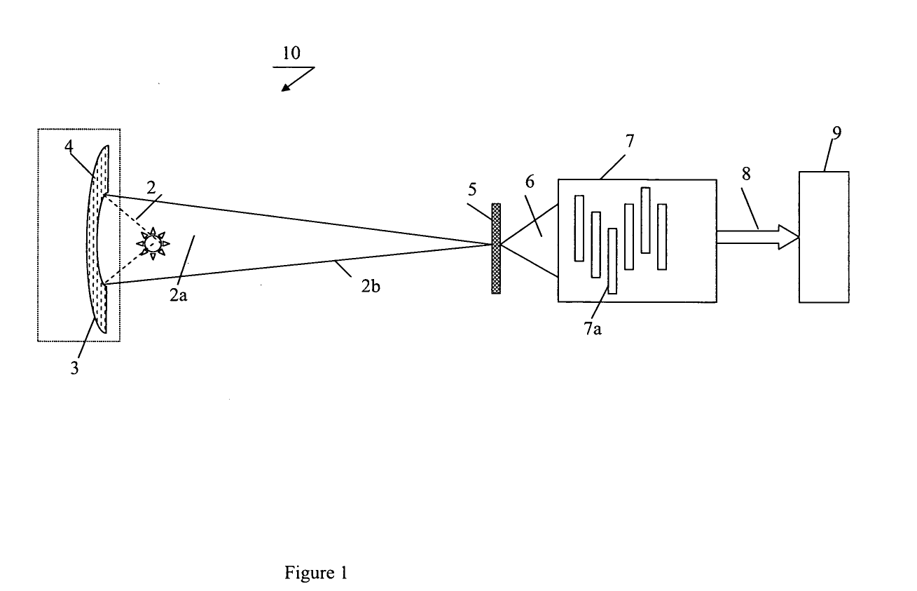

FIG. 1 presents a schematic view of an embodiment of an X-ray microscope 10. A source of EUV radiation 2 is arranged to generate the EUV radiation with a wavelength at least in a range of about 2-6 nm. By way of comparison, it is mentioned that if the source is governed by a radiative collapse, like in a hot plasma, a surface diameter of the source may be decreased about seven times with respect to a conventional EUV source known, for example, in the field of 13.5 nm lithography. As a consequence, a surface radiation area with the same length will be accordingly decreased. A radiation band will decrease by about 1.1, as expressed in energy, and a black body radiation limit will increase about 80 times. As a result, the conversion efficiency for the wave length of 3.1 nm may be as large as about 0.1% (in 2 pi), for example.

The EUV radiation emanating from the source 2, is schematically represented by a ray 2a, and reflects from a suitable mirror comprising a multilayer structure 4 arranged in an illuminator system 3, which may also be referred to as an optical system. The properties of the multilayer structure are set forth in the foregoing. The multilayer structure 4 is arranged to reflect in-phase radiation in accordance with Bragg law of refraction, each individual layer being a reflective surface. The reflected radiation 2b impinges on a suitable sample 5, for example, a biological sample. The sample 5 disperses the beam 2b, thereby yielding a dispersed beam 6, which is collected by a suitable projection module 7. The projection module 7 may comprise a plurality of optical elements, for example, a plurality of mirrors comprising a multilayer structure 7a. The mirrors comprising the multilayer structure 7a may be aspheric mirrors. The projection optical box may comprise 6 multilayer mirrors. A collected beam 8 exits the projection module 7 and passes to a detector 9. The detector 9 may comprise a CCD camera constructed and arranged to produce an electronic image. Alternatively, the detector 9 may comprise an EUV sensitive film.

As discussed above, the multilayer structure may be made from suitable materials for in-phase reflection of the EUV radiation may include any one of the following combinations of materials: Mo/B; La/B₄C; Mo/B₄C; Ru/B₄C; FeCrNi/B₄C; W/B₄C; Al₂O₃/C; Co/C; Ni/C; CrB₂/C; RhRu/C; Ru/C; W/C; V/C; NiCr/C; Fe/C; Ru/C; CO₂C₃/C; Ge/C; FeCrNi/C; W/Sc; Cr/Sc; Al₂O₃/V; Cr/V; Ni/V; Cr/Ti; C/Ti; W/Ti; and Ni/Ti. In an embodiment, the multilayer structure comprises Cr/Sc.

The EUV microscope 10 may be arranged as a table-top microscope to enable investigation of suitable biological samples. The X-ray range between about 2 and 6 nanometers, corresponding to a region between the K_{α} absorption edge of carbon and the K_{α} absorption edge of oxygen, is found to be particularly suitable for investigation of biological matter, because in this range, the absorption of carbon and nitrogen is large, while absorption of oxygen and hydrogen is low. Therefore, by using the range between about 2 and 6 nm, it is possible to observe biological specimens mainly composed of proteins (living tissue) with high resolution in water.

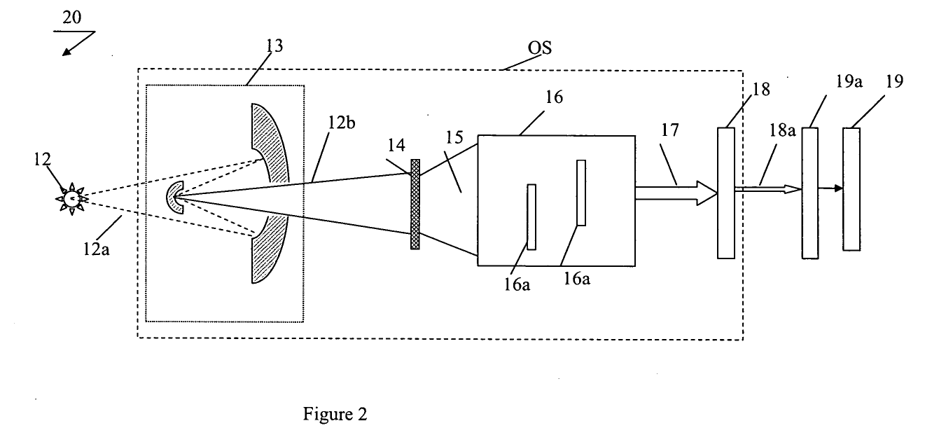

FIG. 2 illustrates an embodiment of an EUV microscope 20. In the embodiment illustrated in FIG. 2, the microscope 20 includes a source 12 that is constructed and arranged to generate an EUV beam 12a. The source 12 impinges on a one-mirror illuminator unit 13. The mirror may be implemented as a spherical Schwarzschild mirror that includes a multilayer structure of the kind discussed above. The Schwarzschild mirror is arranged to illuminate a sample 14 with a radiation beam 12b. A radiation beam 15 is dispersed by the sample 14 and is collected by a projection module 16, which may include two Schwarzschild multilayer mirrors 16a. By keeping a number of reflective surfaces low, for example two, three, or four, EUV mirrors having lower reflectivity may be used. This may provide the possibility of using a switchable objective in the microscope, notably in the optical system of the microscope, which is switchably arranged for enabling sample investigation with different objectives for different wavelengths. This functionality may enable the investigation of different target areas within the sample, notably different species within a cell. A radiation beam 17 that emanates from the projection module 16 is directed to a photon converter unit 18 where the extreme ultraviolet photons may be converted into photons of a visible wave range, i.e. light 18a. The light 18a is then supplied to a visible microscope 19a. From the visible microscope 19a, the light may be supplied to a CCD unit 19 for imaging and/or for further analysis. It will be appreciated that the materials mentioned above may be suitable for manufacturing Schwarzschild mirrors used in an optical system OS of the microscope 20. The optical system OS may include the illuminator unit 13, the projection module 16, and the photon converter 18, as shown in FIG. 2.

While specific embodiments of the invention have been described above, it will be appreciated that the invention may be practiced otherwise than as described. The descriptions above are intended to be illustrative, not limiting. Thus, it will be apparent to one skilled in the art that modifications may be made to the invention as described without departing from the scope of the claims set out below.

What is claimed is:

1. An extreme ultraviolet (EUV) microscope configured to analyze a sample, said microscope comprising:
a source of EUV radiation constructed and arranged to generate the EUV radiation with a wavelength in a range of about 2-6 nm; and
an optical system constructed and arranged to illuminate the sample with the EUV radiation and to collect a radiation emanating from the sample, the optical system being arranged with at least one mirror comprising a multilayer structure for in-phase reflection of at least a portion of the radiation in the range of about 2-6 nm.

2. An EUV microscope according to claim 1, wherein the multilayer structure comprises any one of the following combination of materials: Mo/B, La/B₄C, Mo/B₄C, Ru/B₄C, FeCrNi/B₄C, W/B₄C, Al₂O₃/C, Co/C, Ni/C, CrB₂/C, RhRu/C, Ru/C, W/C, V/C, NiCr/C, Fe/C, Ru/C, CO₂C₃/C, Ge/C, FeCrNi/C, W/Sc, Cr/Sc, Al₂O₃/V, Cr/V, Ni/V, Cr/T, C/Ti, W/Ti, and Ni/Ti.

3. An EUV microscope according to claim 1, wherein said portion of the radiation has a wavelength substantially around 3 nm, and wherein the multilayer structure is arranged with about 200-500 alternating layers.

4. An EUV microscope according to claim 1, wherein the multilayer structure is formed by a repetition of a unit structure having a first layer comprising a first material and a second layer comprising a second material, said unit structure having a thickness in a range of about 1-2 nm.

5. An EUV microscope according to claim 4, wherein the thickness of the first layer is about 0.6-1.5 of the thickness of the second layer.

6. An EUV microscope according to claim 1, wherein the source comprises a discharge plasma source or a laser induced plasma source.

7. An EUV microscope according to claim 1, wherein the microscope is arranged as a table-top unit.

8. An EUV microscope according to claim 1, wherein the optical system comprises an illuminator model arranged with a sole mirror comprising the multilayer structure.

9. An EUV microscope according to claim 1, wherein the optical system comprises a projection module constructed and arranged to collect the radiation, said projection module being constructed and arranged with a plurality of aspheric mirrors comprising the multilayer structure.

10. An EUV microscope according to claim 1, wherein the optical system comprises a projection module constructed and arranged to collect the radiation, said projection module being constructed and arranged with a spherical Schwarzschild mirror comprising the multilayer structure.

11. An EUV microscope according to claim 10, wherein the optical system further comprises a photon converter constructed and arranged to convert the radiation emanating from the projection module into a visible light and to supply the visible light to a visible microscope unit.

12. An EUV microscope according to claim 1, wherein the optical system further comprises a switchable objective constructed and arranged to enable EUV microscopy with different wavelengths.
